(19) United States
(12) Patent Application Publication
(10) Pub. No.: US 2012/0055898 A1
(43) Pub. Date: Mar. 8, 2012

(54) GANTRY WITH SUSPENDING LINKS

(76) Inventor: Stephen Edward Sparrow, Houston, TX (US)

(21) Appl. No.: 13/226,722

(22) Filed: Sep. 7, 2011

Related U.S. Application Data
(60) Provisional application No. 61/380,844, filed on Sep. 8, 2010.

(51) Int. Cl. B66C 17/00

(52) U.S. Cl. 212/71

(57) ABSTRACT

The gantry system (10) includes jack legs (12) and header beams (14). The load may be supported on a metal chain (20) comprising of a plurality of metal links (24). Each link has a stop surface (28) for engaging a support plate (30) laterally movable with respect to support structure (18).

### CROSS-REFERENCE TO RELATED APPLICATION

This application claims the priority of U.S. Provisional Application No. 61/380,844 filed on Sep. 8, 2010 the disclosure of which is incorporated herein by reference for all purposes.

### FIELD OF THE INVENTION

The present invention relates to gantries of the type commonly used for moving a heavy load. More particularly, the invention relates to a gantry with a plurality of links for lifting a load, with the links capable of suspending a load independent of the hydraulic jack legs.

### BACKGROUND OF THE INVENTION

A hydraulic gantry is a well-known lifting and moving device having two or more hydraulic jack legs, one or more header beams, and devices for rigging. The hydraulic jack legs are capable of lifting very large loads, e.g., for construction, storage or transportation purposes. Hydraulic jack leg units use hydraulic cylinders, and loads are conventionally rigged to and hang from the header beam. Once the load is lifted, the load may be transported with hydraulic propel jacks or hydraulic propel wheels.

A hydraulic gantry system frequently has problems where the load must be lifted above an obstruction before it can be transported, but there is limited head room for lifting. A gantry conventionally requires a large amount of head room above the header beam for accommodating the strand jacks and strand guides above the header beam. With conventional gantries, an overhead obstruction often means days of disassembling the apparatus to pass under a load beam. Other extensive and time consuming steps may be taken to support the headroom problem for a conventional gantry system, although the conventional solution continues to involve disassembly of the load and/or special rigging.

One prior art system uses a specially made support frame to support the load, lifting bars to lift the support frame and the load, and separate suspension bars to suspend the load from the header. This design has three components to handle the load, namely a special support frame, a lifting bar, and a suspension bar. This system is both expensive to manufacture and maintain, and time consuming to use.

A gantry system with adjustable side supports is disclosed in U.S. Pat. No. 4,381,839. U.S. Pat. No. 4,718,563 discloses an overhead gantry spanning a roadway. A gantry with a harmonic lift drive is disclosed in U.S. Pat. No. 6,543,605, and U.S. Pat. No. 7,073,673 discloses a wire rope reeving support system for a gantry. U.S. Pat. No. 4,057,194 discloses a container overhead transfer and storage system.

The disadvantages of the prior art are overcome by the present invention, an improved gantry lift system is hereinafter disclosed.

### SUMMARY OF THE INVENTION

In one embodiment, a hydraulic gantry is provided for lifting and moving a load, including a plurality of hydraulic jack legs and one or more header beams supported at the upper end of the hydraulic jack legs. A plurality of vertical links forming a chain suspended from one of the header beams, with each link pivotally connected to another of the plurality of links and including at least two planar stop surfaces thereon. A support plate below the header beam is moved laterally from a disengaged position to an engaged positioned such that the plurality of stand jacks may lower a link to engage a support surface and thereby suspend the load from the support plate. Rigging may be used to connect the load to the chain, such that the load may be supported on the support plate when fluid pressure is reduced to the plurality of the hydraulic jack legs. One or more links may then be removed from the chain, and the shortened chain desirably reduces the vertical spacing between the header and the load.

These and further features and advantages of the present invention will become apparent from the following detailed description, wherein reference is made to the figures in the accompanying drawings.

### BRIEF DESCRIPTION OF THE DRAWINGS

FIG. 1 illustrates one embodiment of a gantry according to the present invention.

FIG. 2 illustrates in further detail the lifting and suspension links.

FIG. 3 illustrates in greater detail the lifting links and suspension links.

FIG. 4 illustrates a prior art gantry system with a low overhead clearance.

FIG. 5 illustrates the difference in required operating headroom for the gantry of this invention.

FIG. 6 illustrates the gantry system with links removed to lower the header beam.

### DETAILED DESCRIPTION OF PREFERRED EMBODIMENTS

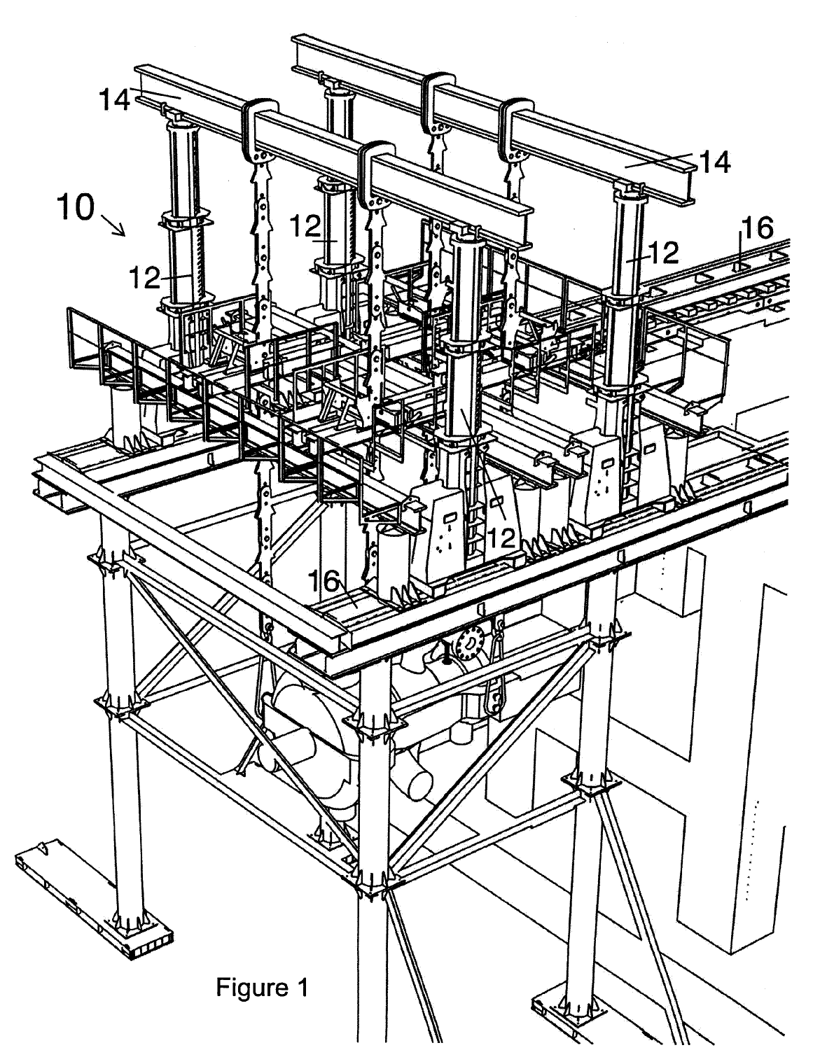

The gantry system 10 as shown in FIG. 1 includes four hydraulic jack legs 12 and two header beams 14, with each header beam being supported at the upper end of two associate hydraulic jack legs. The gantry system further includes a runway track 16 for moving the header beams and a load, which in FIG. 1 is depicted by load L. Support structure 18 is provided for supporting a base of each strand jack above the load L. Other systems may include six or more hydraulic jack legs and/or three or more header beams.

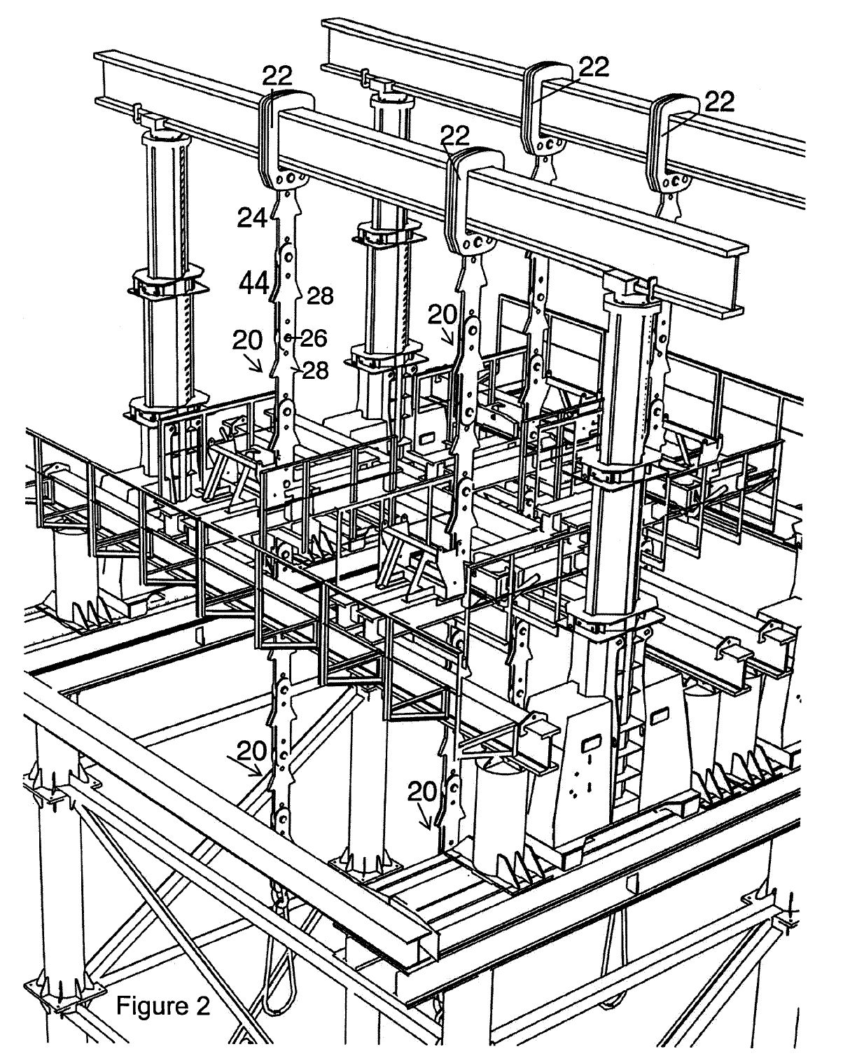

FIGS. 1 and 2 depict a portion of the gantry shown in FIG. 1, including the hydraulic jack legs 12, the header beam 14 and the track 16. FIG. 2 also more clearly depicts a beam clamp 22 for supporting a metal chain 20, which in this case comprises a plurality of metal links 24. The chain 20 comprising metal links thus hangs from the beam clamp 22 and thus from a header beam 14.

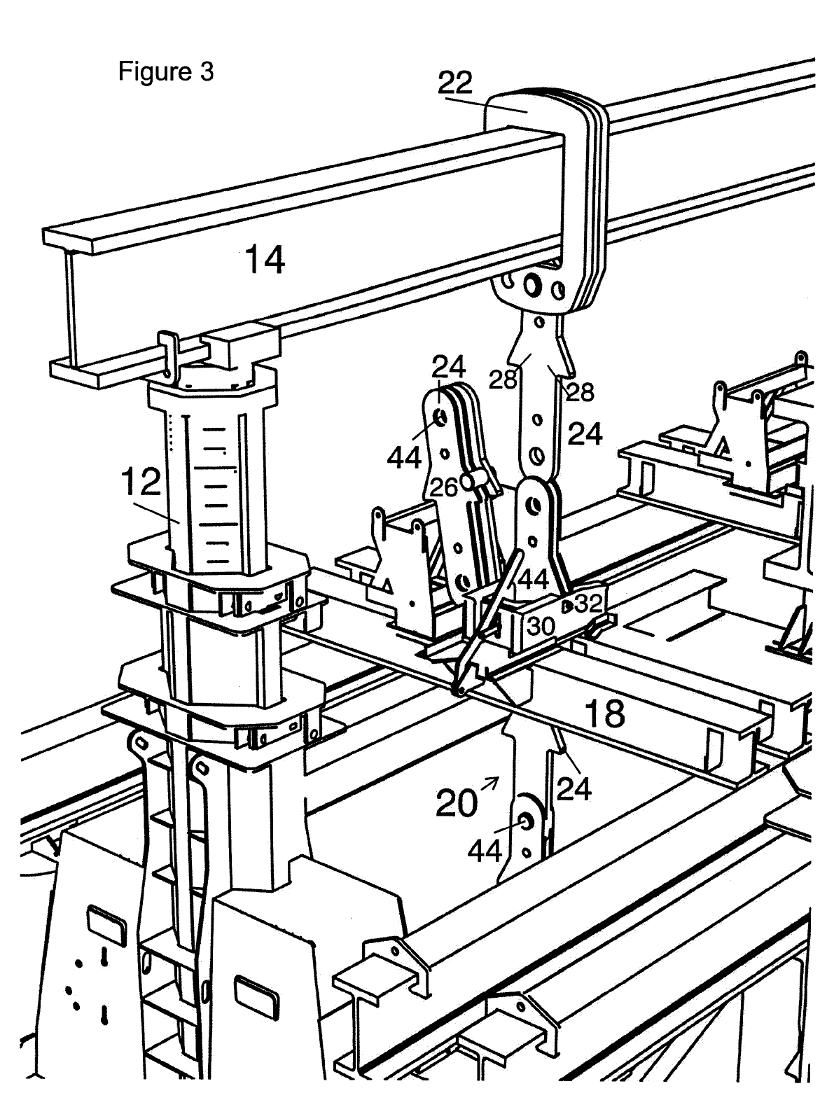

FIG. 3 more clearly depicts that the metal chain 20 comprises a series of two parallel links 44, followed by a single metal link 24, followed by a pair of parallel links, etc. The spacing between the pair of metal links is conveniently the thickness of the single link. Each link has an upper aperture for receiving a pin 26, and a lower aperture for receiving a similar pin 26, such that a single link points with respect to the pair of links, and the pair of links together pivot with respect to the single link. Each link also has a stop surface 28, and in this case has a pair of stop surfaces 28 on opposing sides of each metal link. Each stop surface 28 is a planar surface intended for substantially planar engagement with support plate 30, which is laterally movable with respect to support structure 18. Support plate 30 may be movable from a disengaged position wherein the links freely pass by the support plate, to an engaged position as shown in FIG. 3 when the link and the load is supported form the plate 30. The planar surfaces 28 engage the planar support surfaces 32 on the support plate, so that the load is supported by the support plate and the links below the support plate. Accordingly, upper links may then be removed from the chain so that the header beam is lowered with respect to the load.

Once the load has been lifted to the necessary height, the support structure may be connected to the two header beams via a lifting sling or chain 34. On the next extension of the hydraulic jack legs, the supporting structure and the load are raised together to clear of the gantry tracks and the entire system is then free to travel along the gantry tracks to the desired position. The previously described lifting process is then reversed to lower and place the load.

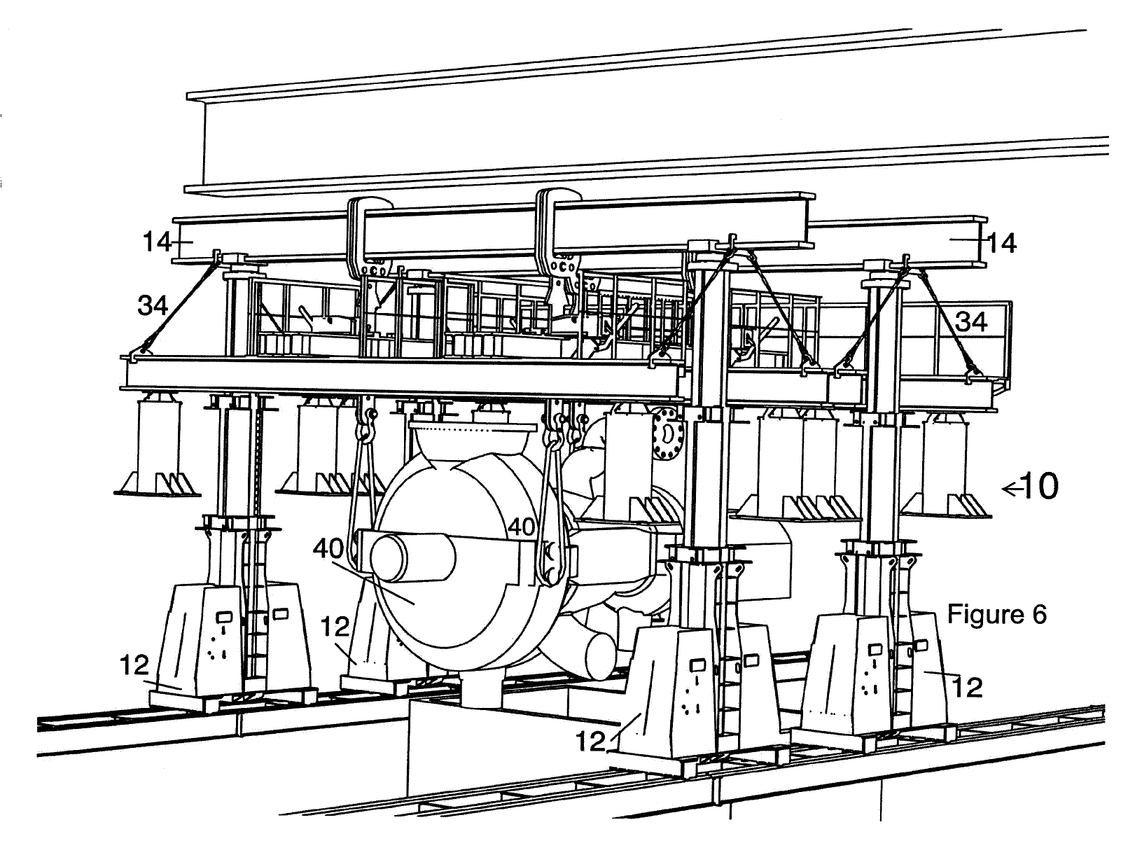

FIG. 6 conceptually depicts a portion of the gantry 10 shown in FIG. 1 with less clearance load, i.e., links have been removed from the chains to lower the header beam 14 with respect to the load until the chain consists of a single link (or 3 links) with standard rigging 40 supporting the load and connected to the lower end of the links. A load positioned as shown in FIG. 1 may thus be raised with respect to the header beam 14 to a position as shown in FIG. 6. The gantry system of the present invention is fully capable of operation with relatively low headroom. Depending on the application, the spacing between connecting pins at the upper and lower end of a link may be approximately 3½ feet, but as disclosed above a preferred system utilizes two-spaced links followed by a single center link, followed by two-spaced link, etc. Accordingly, both a pair of links and a single links are commonly removed during restroking of the jack legs, so that the system will require less than ten feet of overhead clearance for reliable operation.

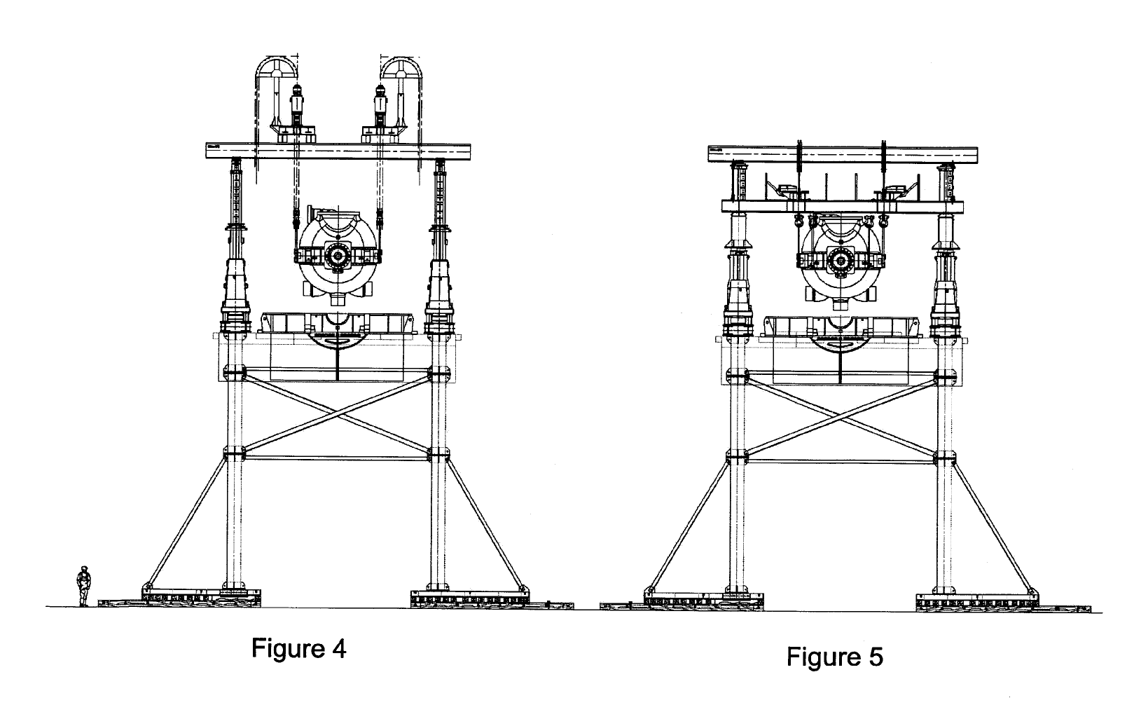

FIG. 4 shows a conventional gantry system, and illustrates the large amount of headroom required for the strand guides above the header beam and the spacing between the header beam and load. FIG. 5 illustrates one embodiment of the gantry system according to the present invention, wherein the headroom has been substantially reduced by the features of this invention.

The hydraulic jack legs themselves need not be modified, so that these complicated and precision assemblies are not adversely affected by the present system. The system also has a comparatively low cost, and fabrication of the links is significantly less than the price of a single strand jack. The absence of electronic and sensitive components ensures that this system is not affected by moisture, dust, or climate, and the system is robust for rough handling. With the system of the present invention, the load is always under positive control by either a jack leg or by engagement of a link with a support plate.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. A hydraulic gantry for lifting and moving a load, comprising:
a plurality of hydraulic jack legs;
one or more header beams supported at an upper end of the hydraulic jack legs;
a plurality of vertical links forming a chain suspended from one of the one or more header beams;
each link pivotally connected to another of the plurality of links, each link further including two stop surfaces thereon;
a support plate below a header beam for moving from a disengaged position wherein the links pass by the support plate to an engaged position wherein the plurality of hydraulic jack legs lower a link to engage the support surface and thereby suspend the load from the support plate; and
rigging to connect the load to the chain, such that a link may supported on the support plate and fluid pressure relieved from the plurality of hydraulic jack legs as the hydraulic jack legs are lowered; and
one or more links removable from the chain such that a shortened chain reduces the vertical spacing between the header beam and the load.

2. The hydraulic gantry as defined in claim 1, wherein the two stop surfaces are on opposing sides of a respective link.

3. The hydraulic gantry as defined in claim 1, wherein the chain comprises two spaced apart and substantially parallel plates forming a link, and a third plate pivotally connected to the two plates and forming another link.

4. The hydraulic gantry as defined in claim 1, wherein the two stop surfaces on each link are substantially planar stop surfaces each for planar engagement with the support plate.

5. The hydraulic gantry as defined in claim 1, wherein the support plate is laterally movable from the disengaged position to the engaged position.

6. The hydraulic gantry as defined in claim 1, further comprising:
a runway track for moving the one or more header beams laterally.

7. The hydraulic gantry as defined in claim 1, further comprising:
a beam clamp for interconnecting the chain and a respective header beam.

8. The hydraulic gantry as defined in claim 1, wherein each link is formed from metal.

9. The hydraulic gantry as defined in claim 1, wherein the plurality of hydraulic jack legs includes four or more hydraulic jack legs.

10. The hydraulic gantry as defined in claim 9, wherein the one or more header beams includes two or more header beams.

11. A hydraulic gantry for lifting and moving a load, comprising:
four or more hydraulic jack legs;
two or more header beams each supported at an upper end of a pair of the four or more hydraulic jack legs;
a plurality of vertical links forming a chain suspended from one or more of the header beams;
each link pivotally connected to another of the plurality of links, each link further including two stop surfaces on opposing sides of the link;
a support plate below a header beam for moving from a disengaged position wherein the links pass by the support plate to an engaged position wherein the plurality of hydraulic jack legs lower a link to engage the support surface and thereby suspend the load from the support plate; and
rigging to connect the load to the chain, such that a link may supported on the support plate and fluid pressure relieved from the plurality of hydraulic jack legs as the hydraulic jack legs are lowered.

12. The hydraulic gantry as defined in claim 11, wherein the chain comprises two spaced apart and substantially parallel plates forming a link, and a third plate pivotally connected to the two plates and forming another link.

13. The hydraulic gantry as defined in claim 11, further comprising:
a runway track for moving the one or more header beams laterally.

14. The hydraulic gantry as defined in claim 11, wherein the two stop surfaces on each link are substantially planar stop surfaces each for planar engagement with the support plate.

15. The hydraulic gantry as defined in claim 11, further comprising:
a runway track for moving the one or more header beams laterally.

16. A hydraulic gantry for lifting and moving a load, comprising:
a plurality of hydraulic jack legs;
one or more header beams supported at an upper end of the hydraulic jack legs;
a plurality of vertical links forming a chain suspended from one or more of the header beams, the chain comprising two spaced apart and substantially parallel plates forming a link, and a third plate pivotally connected to the two plates and forming another link;
each link pivotally connected to another of the plurality of links, each link further including two planar stop surfaces thereon on opposing sides of the link;
a support plate below a header beam for moving from a disengaged position wherein the links pass by the support plate to an engaged position wherein the plurality of hydraulic jack legs lower a link to engage the support surface and thereby suspend the load from the support plate; and
rigging to connect the load to the chain, such that a link may supported on the support plate and fluid pressure relieved from the plurality of hydraulic jack legs as the hydraulic jack legs are lowered.

17. The hydraulic gantry as defined in claim 16, further comprising:
a runway track for moving the one or more header beams laterally.

18. The hydraulic gantry as defined in claim 16, further comprising:
a beam clamp for interconnecting the chain and a respective header beam.

19. The hydraulic gantry as defined in claim 16, wherein the plurality of hydraulic jack legs includes four or more hydraulic jack legs.

20. The hydraulic gantry as defined in claim 16, a portion of the chain is removed such that the shortened chain reduces the vertical spacing between the header beam and the load.
